(19) United States
(12) Patent Application Publication
(10) Pub. No.: US 2025/0053670 A1
(43) Pub. Date: Feb. 13, 2025

(54) A CLOUD-BASED ERP SYSTEM FOR SECURE DATA EXCHANGE BETWEEN ENTITIES

(71) Applicants: LIPIKA SAHOO, BANGALORE (IN); MANOJ KUMAR SAHOO, BANGALORE (IN)

(72) Inventors: LIPIKA SAHOO, BANGALORE (IN); MANOJ KUMAR SAHOO, BANGALORE (IN)

(21) Appl. No.: 18/723,533

(22) PCT Filed: Dec. 23, 2022
(86) PCT No.: PCT/IB2022/062742

§ 371 Date: Jun. 24, 2024

(30) Foreign Application Priority Data
Dec. 23, 2021 (IN) 202141060251

(51) Int. Cl. G06F 21/60

(52) U.S. Cl. CPC G06F 21/606

(57) ABSTRACT

An aspect of the present invention facilitates secure data exchange between entities. In one embodiment, an Enterprise Resource Planning (ERP) system (provided according to aspects of the present invention) sends on behalf of a first entity, a link to a second entity, the first entity being an authorized user of the ERP system and the second entity being an unauthorized user of the ERP system. Upon receiving an indication that the link has been selected by the second entity in an end user system, the ERP system verifies the second entity based on the link and facilitates the second entity to either view a first data stored in the ERP system or add a second data to the ERP system.

### BACKGROUND OF THE INVENTION

### Technical Field

The present disclosure relates to enterprise systems and more specifically to a cloud-based Enterprise Resource Planning (ERP) system for secure data exchange between entities.

### Related Art

An ERP system is commonly used by business organizations to manage day-to-day business activities such as accounting, procurement, project management, risk management and compliance, and supply chain operations. When an ERP system is hosted in a cloud infrastructure (such as Amazon Web Services (AWS) available from Amazon.com, Inc., Google Cloud Platform (GCP) available from Google LLC, etc.), it is referred to as a cloud-based ERP system.

In the following disclosure, the term “entities” is used to refer to any user associated with the ERP system. Examples of entities are business organizations, customers of the business organizations, staff/employees of the business organizations, administrators of the ERP system, auditors, etc. Some of the entities may be authorized entities/users (such as business organizations) that have access privileges (view, add, modify) for the data stored in the ERP system, while other entities may be unauthorized entities/users (such as customers) that do not have such access privileges.

Accordingly, there is a need to provide secure data exchange between entities, specifically between the authorized and unauthorized entities.

### SUMMARY OF THE INVENTION

An aspect of the present invention facilitates secure data exchange between entities. In one embodiment, an ERP system (provided according to aspects of the present invention) sends on behalf of a first entity, a link to a second entity, the first entity being an authorized user of the ERP system and the second entity being an unauthorized user of the ERP system. Upon receiving an indication that the link has been selected by the second entity in an end user system, the ERP system verifies the second entity based on the link and facilitates the second entity to either view a first data stored in the ERP system or add a second data to the ERP system.

According to another aspect of the present invention, the link is a Uniform Resource Locator (URL) containing a first part and a second part, the first part causing the indication to be sent to the ERP system when the link is selected by the second entity and the second part being used for verifying the second entity.

According to one more aspect of the present invention, the first entity is enabled to specify a maximum count of the times the second entity is allowed to select the link. As such, the ERP system maintains a running count of the times when the indication is received and performs the actions of verifying and facilitating only when the running count is less than or equal to the maximum count.

According to yet another aspect of the present invention, the first entity is enabled to specify a periodic alert to be sent to the second entity. Accordingly, the ERP system sends the periodic alerts to the second entity until the first data is viewed by the second entity or until the second data is added to the ERP system.

According to an aspect of the present invention, the facilitating comprises providing a user interface to be displayed to the second entity on the end user system, the user interface including the first data thereby enabling the second entity to view the first data. In one embodiment, the first entity is a business organization, the second entity is a customer of the business organization, and the first data is an invoice/purchase order for the customer raised by the business organization.

According to another aspect of the present invention, the facilitating comprises providing a user interface to be displayed to the second entity on the end user system, receiving from the end user system, the second data specified by the second entity using the user interface and storing the second data in the ERP system thereby enabling the second entity to add the second data to the ERP system. In one embodiment, the first entity is a business organization, the second entity is a customer of the business organization, and the second data is a unique identification number of the customer required by the business organization.

Several aspects of the invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### BRIEF DESCRIPTION OF THE DRAWINGS

Example embodiments of the present invention will be described with reference to the accompanying drawings briefly described below.

FIG. 1 is a block diagram illustrating an example computing system in which various aspects of the present invention can be implemented.

FIG. 2 is a flow chart illustrating the manner in which secure data exchange between entities is facilitated according to aspects of the present invention.

FIG. 3 depicts sample data maintained by an ERP system in one embodiment.

FIG. 4 depicts a sample user interface provide by an ERP system in one embodiment.

FIG. 5 is a block diagram illustrating the details of a digital processing system in which various aspects of the present invention are operative by execution of appropriate execution modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

The use of “including”, “comprising”, or “having” and variations there of herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

As used herein, the singular forms “a”, “an”, and “the” include both singular and plural referents unless the context clearly dictates otherwise. By way of example, “a dosage” refers to one or more than one dosage. The terms “comprising”, “comprises” and “comprised of” as used herein are synonymous with “including”, “includes” or “containing”, “contains”, and are inclusive or open-ended and do not exclude additional, non-recited members, elements, or method steps.

All documents cited in the present specification are hereby incorporated by reference in their totality. In particular, the teachings of all documents herein specifically referred to are incorporated by reference.

Example embodiments of the present invention are described with reference to the accompanying figures.

### 1. Example Environment

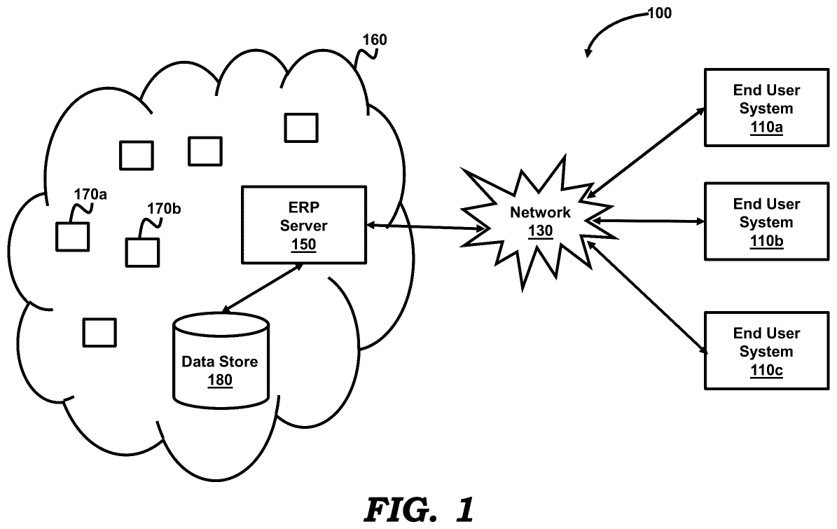

FIG. 1 is a block diagram illustrating an example computing system (100) in which various aspects of the present invention can be implemented. The block diagram is shown containing end user systems 110a-110c, network 130, and cloud 160 (which in turn is shown containing a number of nodes such as node 170a and 170b, ERP server 150 and data store 180).

Merely for illustration, only representative number/type of systems is shown in FIG. 1. Many computing systems often contain many more systems, both in number and type, depending on the purpose for which the computing system is designed. Each system/device of FIG. 1 is described below in further detail.

Network 130 provides connectivity between end user systems 110a-110c and nodes of cloud 160 (such as node 170a/170b, ERP system 150 and data store 180). Network 130 may represent Wireless/LAN networks implemented using protocols such as Transport Control Protocol/Internet Protocol (TCP/IP), or circuit switched network implemented using protocols such as GSM, CDMA, etc. as is well known in the relevant arts.

In general, network 130 provides transport of packets, with each packet containing a source address (as assigned to the specific system from which the packet originates) and a destination address, equaling the specific address assigned to the specific system to which a packet is destined/targeted. The packets would generally contain the requests and responses between end user systems 110a-110c and nodes of cloud 160 (such as node 170a/170b, ERP system 150 and data store 180) as described in detail in the below sections.

Each of end user systems 110a-110c represents a system such as a personal computer, workstation, mobile phone (e.g., iPhone available from Apple Corporation), tablet, portable device (also referred to as “smart” devices”) that operate with a generic operating system such as Android operating system available from Google Corporation, etc., used by users to send (user) requests to nodes of cloud 160 such as ERP system 150. In addition, each of end user systems 110a-110c may include various hardware (and corresponding software) sensors such as camera, microphone, accelerometers, etc. In general, an end user system enables a user to send user requests for performing desired tasks to ERP system 150 and to receive corresponding responses containing the results of performance of the requested tasks.

Cloud 160 is a collection of nodes (such as node 170a/170b) that may include processing nodes, connectivity infrastructure, data storages, administration systems, etc., which are engineered to together host software applications. Cloud 16 may be provided on a public cloud infrastructure (such as Amazon Web Services (AWS) available from Amazon.com, Inc., Google Cloud Platform (GCP) available from Google LLC, etc.) that provides a virtual computing infrastructure for various customers, with the scale of such computing infrastructure being specified often on demand. Alternatively, cloud 160 may be provided on an enterprise system (or a part thereof) on the premises of the business organizations. Cloud 160 may also be a “hybrid” infrastructure containing some nodes of a public cloud infrastructure and other nodes of an enterprise system. Some of the nodes of cloud 160 may be implemented as corresponding data stores similar to data store 180, while other nodes of the cloud 160 may be implemented as corresponding server systems, similar to ERP system 150.

ERP server 150 represents a system, such as a web and/or application server, executing various ERP applications designed to perform one or more tasks (related to accounting, procurement, project management, risk management and compliance, supply chain operations, etc.). ERP server 150 may perform the tasks using data maintained internally to ERP server 150, on external data (e.g., maintained in data store 180) or on data received as part of the requests (e.g., data received from end user systems 110a-110c). ERP server 150 may also send the results of performance of the tasks to end user systems 110a-110c or one or more nodes of cloud 160. Furthermore, ERP server 150 may maintain some of the received information (such as the data from end user systems 110a-110c) and the result of performance of the tasks in data store 180.

Data store 180 represents a non-volatile storage, facilitating storage and retrieval of a collection of data by ERP server 150. Data store 180 may maintain information such as user data received from end user systems 110a-110c, data related to performance of tasks noted above, etc. In one embodiment, data store 180 is implemented using relational database technologies where the data is maintained in the form of databases containing tables and columns and provides storage and retrieval of data using structured queries such as SQL (Structured Query Language), as is well known in the relevant arts. Alternatively, data store 180 may be implemented as a file server and store data in the form of one or more files organized in the form of a hierarchy of directories, as is well known in the relevant arts.

It may be appreciated that each of ERP server 150 and data store 180 are implemented on corresponding nodes of cloud 160. Accordingly, ERP server 150 and data store 180 together operate as a cloud-based ERP system. The ERP system may be operated on behalf of a single business organization or for multiple business organization.

As is well known, every business organization needs to share business data like invoices/purchase orders (PO) with their customers and there is an inherent need to collect business information like GST (Goods and Services Tax) number and PAN (Permanent account number) number from their customers as they are unique identification numbers associated with the customers. In prior approaches, such requirements have been implemented thorough phone calls/emails and authorized users of the ERP system who has access privileges to customer data/sales data either update the data in the ERP system or download the sales invoice/PO and share with customers via external means (email/print etc.). Currently there is no secure way for users at different business organizations or other entities to have the benefits of sharing files or collaborating work between enterprises on a daily basis. So, there is a need to have a system to support the entry, download, sharing of the business data by unauthorized users in a secure manner.

ERP server 150, provided according to aspects of the present invention, facilitates secure exchange of data between entities while overcoming some of the drawbacks noted above. The manner in which ERP server 150 facilitates secure exchange of data between entities is described below with examples.

### 2. General Flow

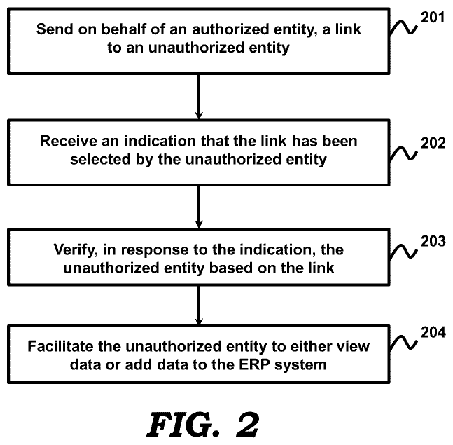

FIG. 2 is a flow chart illustrating the manner in which secure data exchange between entities is facilitated according to aspects of the present invention. The flowchart is described with respect to FIG. 1, in particular, ERP server 150, merely for illustration. However, various features can be implemented in other systems and/or other environments also without departing from the scope of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention.

In step 201, ERP server 150 sends on behalf of an authorized entity/user, a link to an unauthorized entity/user. The authorized entity may be a business organization, while the unauthorized entity may be a customer of the business organization. According to an aspect, the link is a Uniform Resource Locator (URL) containing a first part and a second part. The link may be sent as part of an email communication to the unauthorized entity/user.

In step 202, ERP server 150 receives an indication that the link has been selected by the unauthorized entity in an end user system (110a-110c). According to an aspect, the first part of the URL causes the indication to be sent to the ERP server 150 when the when the link is selected/clicked on by the unauthorized entity/user in the end user system.

In step 203, ERP server 150 verifies, in response to the indication, the unauthorized entity based on the link. According to an aspect, the second part of the URL is used for verifying the unauthorized entity/user.

In step 204, ERP server 150 facilitates the unauthorized entity/user to either view data or add data to the ERP system. According to an aspect, ERP server 150 provides a user interface including the data (such as invoices/POs stored in data store 180) thereby enabling the unauthorized user to view the data. Alternatively, ERP server 150 provides a user interface that enables the user to provide data to be added, receives the user provided data and stores the user provided data in data store 180, thereby facilitating the unauthorized user to add data to the ERP system.

Thus, aspects of the invention facilitate secure exchange of data between entities. The manner in which ERP server 150 according to the operation of FIG. 2 may be implemented is described below with examples.

### 3. Illustrative Example

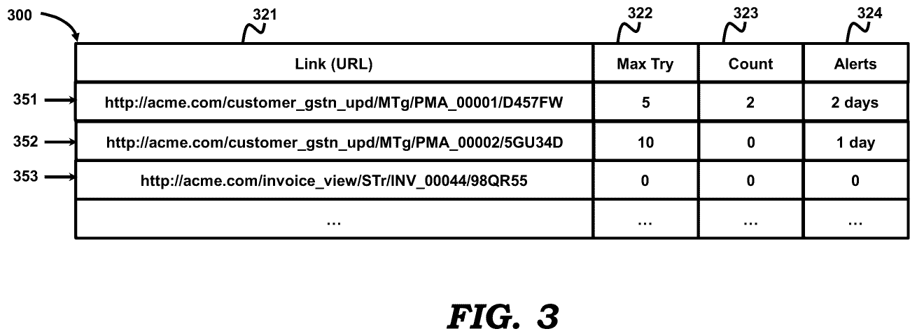

FIG. 3 depicts sample data maintained by an ERP system in one embodiment. The data may be maintained by ERP server 150 in data store 180 in any convenient format. For example, as shown, the data may be maintained in the form of one or more tables in a database when data store 180 is implemented using relational database technologies. Alternatively, the data may be maintained in the form of files or other data structures (such as lists, trees, etc.) as will be apparent to one skilled in the relevant arts by reading the disclosure herein.

Table 300 depicts the data maintained by ERP server 150. Column 321 specifies a link/URL that may be sent to unauthorized users (such as customers of a business organization), column 322 specifies the maximum number of times the unauthorized user is allowed to select the corresponding link (a value of “0” indicating that there is no maximum), column 323 specifies the current number of times the unauthorized user has accessed/selected the corresponding link, and column 324 specifies the period for sending alerts to the unauthorized user.

Each of rows 351-353 specifies the details of corresponding links/URLs. It may be appreciated that the data of rows 351-353 may be generated in response to authorized users (such as employees of the business organization) specifying that the corresponding information (such as invoice, PO, GST, PAN) is required to be shown to or to be obtained from the customers of the business organization. The data of columns 322-324 may be entered by the authorized users or may be generated based on policies implemented in the ERP system.

It may be appreciated that each link/URL has two parts. For example, in row 351, the link/URL shown in column 321 has two parts—a first part “http://acme.com/customer_gstn_upd/MTg/PMA_00001/” that causes the indication to be sent to ERP server 150 and a second part “D457FW” that is used by ERP server 150 to verify (identify and authorize) the customer.

During operation, ERP server 150 sends the links (in corresponding emails) to various customers of the business organization. When a customer selects/clicks a link (assumed to be the link in row 351 for illustration) using an end user system (assumed to be 110a for illustration), the first part of the URL (noted above) causes an indication to be received at ERP server 150. In particular, the URL causes a packet to be sent to ERP server 150, the packet indicating the IP address of the specific end user system 110a used by the customer.

ERP server 150 then increments the count by 1 in column 323 in row 351 and checks whether the incremented count is less than or equal to the max try in column 322 in row 351, that is, the value 5. If the count is less than or equal to the max try value (5), ERP server 150 provides a user interface to the customer as described below. On the other hand, when the count is greater than the max try value, ERP server 150 does not provide any user interface and may provide/display a message indicating that the URL/link is no longer valid.

According to an aspect, ERP server 150 also monitors whether there are any of the links/URLs where no indications have been received (Count=0 in column 323). If any such links are present, ERP server 150 sends periodic alerts to the customer as per the period specified in column 324 until an indication is received (that is, until the invoice/PO is viewed by the customer or until the GST/PAN number is added by the customer to the ERP system).

The manner in which ERP server 150 provides a user interface for viewing/adding data is described below with examples.

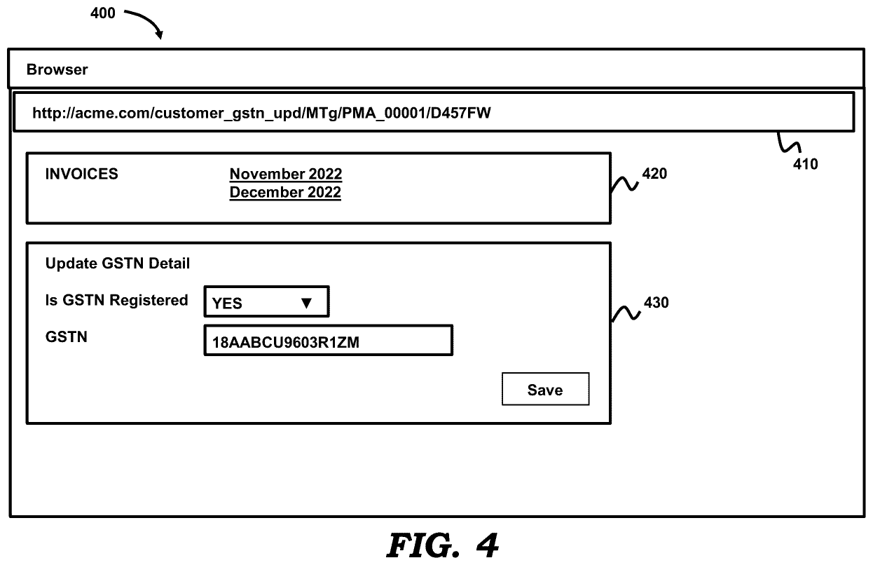

FIG. 4 depicts a sample user interface provide by an ERP system in one embodiment. The user interface may be provided by ERP server 150 in response to unauthorized users/customers of the business organization selecting/clicking the links/URLs shown in FIG. 3. The user interface may be displayed on a display unit (not shown in the FIG.s) associated with end user system 110a.

Display area 400 depicts a portion of a user interface provided to a customer (unauthorized user) when the customer has selected the link/URL shown in display area 410. Display area 420 displays a list of invoices (as links “November 2022”, “December 2022”) that can be viewed by the customer by clicking the respective link. The list of invoices may be generated based on data maintained in data store 180.

Display area 430 enables the customer to provide the details of his/her GST number. Upon entering the desired details in display area 430, the customer may select/click button “Save” there to cause the data to be sent to ERP server 150. Upon receiving the data entered in display area 430, ERP server 150 stores the received data in data store 180.

Thus, the cloud-based ERP system of ERP server 150 and data store 180 facilitates secure data exchange between entities. It may be appreciated that the instant invention has various advantages such as no manual follow-up to get and share the business data, improves efficiency (save other resource time), eliminates error in the manual process, and data validation is done by the beneficiary party (customers), hence reduces the business risk of wrong input credit.

It should be appreciated that the above noted features can be implemented in various embodiments as a desired combination of one or more of hardware, execution modules and firmware. The description is continued with respect to one embodiment in which various features are operative when execution modules are executed.

### 5. Digital Processing System

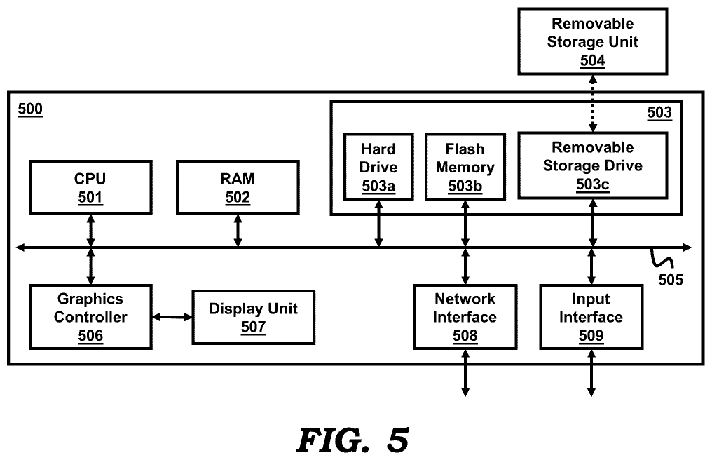

FIG. 5 is a block diagram illustrating the details of digital processing system 500 in which various aspects of the present invention are operative by execution of appropriate execution modules. Digital processing system 500 may correspond to ERP server 150.

Digital processing system 500 may contain one or more processors (such as a central processing unit (CPU) 501), random access memory (RAM) 502, secondary memory 503, graphics controller 506, display unit 507, network interface 508, and input interface 509. All the components except display unit 507 may communicate with each other over communication path 505 which may contain several buses as is well known in the relevant arts. The components of FIG. 5 are described below in further detail.

CPU 501 may execute instructions stored in RAM 502 to provide several features of the present invention. CPU 501 may contain multiple processing units, with each processing unit potentially being designed for a specific task. Alternatively, CPU 501 may contain only a single general-purpose processing unit. RAM 502 may receive instructions from secondary memory 503 using communication path 505.

Graphics controller 506 generates display signals (e.g., in RGB format) to display unit 507 based on data/instructions received from CPU 501. Display unit 507 contains a display screen to display the images defined by the display signals (for example, portions of the user interface shown in FIG. 4). Input interface 509 may correspond to a keyboard and a pointing device (e.g., touch-pad, mouse), which enable the various inputs to be provided (for example, in the portions of the user interface shown in FIG. 4).

Network interface 508 provides connectivity to a network (e.g., using Internet Protocol), and may be used to communicate with other connected systems. Network interface 508 may provide such connectivity over a wire (in the case of TCP/IP based communication) or wirelessly (in the case of WIFI, Bluetooth based communication).

Secondary memory 503 may contain hard drive 503a, flash memory 503b, and removable storage drive 503c. Secondary memory 503 may store the data (e.g., portions of the data shown in FIG. 3) and software instructions (e.g., for implementing the steps of FIG. 2), which enable digital processing system 500 to provide several features in accordance with the present invention.

Some or all of the data and instructions may be provided on removable storage unit 504, and the data and instructions may be read and provided by removable storage drive 503c to CPU 501. Floppy drive, magnetic tape drive, CD-ROM drive, DVD Drive, Flash memory, removable memory chip (PCMCIA Card, EPROM) are examples of such removable storage drive 503c.

Removable storage unit 64 may be implemented using storage format compatible with removable storage drive 503c such that removable storage drive 63c can read the data and instructions. Thus, removable storage unit 504 includes a computer readable storage medium having stored therein computer software (in the form of execution modules) and/or data.

However, the computer (or machine, in general) readable storage medium can be in other forms (e.g., non-removable, random access, etc.). These “computer program products” are means for providing execution modules to digital processing system 500. CPU 501 may retrieve the software instructions (forming the execution modules) and execute the instructions to provide various features of the present invention described above.

It should be understood that the figures and/or screen shots shown above highlighting the functionality and advantages of the present invention are presented for example purposes only. The present invention is sufficiently flexible and configurable, such that it may be utilized in ways other than that shown in the figures.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the invention have been shown and described in detail to illustrate the inventive principles, it will be understood that the invention may be embodied otherwise without departing from such principles.

It should be understood that the examples and embodiments described herein are for illustrative purposes only and that various modifications or changes in light thereof will be suggested to persons skilled in the art and are to be included within the spirit and purview of this application and scope of the appended claims.

I/We claim:

1. A method for secure data exchange between entities, the method being performed by an Enterprise Resource Planning (ERP) system, the method comprising:
sending on behalf of a first entity, a link to a second entity, wherein the first entity is an authorized user of the ERP system and the second entity is an unauthorized user of the ERP system;
receiving an indication that the link has been selected by the second entity in an end user system;
verifying, in response to the indication, the second entity based on the link; and
facilitating the second entity to either view a first data stored in the ERP system or add a second data to the ERP system.

2. The method of claim 1, wherein the link is an Uniform Resource Locator (URL) containing a first part and a second part,
wherein the first part causes the indication to be sent to the ERP system when the link is selected by the second entity,
wherein the second part is used for verifying the second entity.

3. The method of claim 1, wherein the first entity is enabled to specify a maximum count of the times the second entity is allowed to select the link,
wherein the ERP system maintains a running count of the times when the indication is received,
wherein the verifying and the facilitating is performed only when the running count is less than or equal to the maximum count.

4. The method of claim 1, wherein the first entity is enabled to specify a periodic alert to be sent to the second entity,
wherein the ERP system sends the periodic alerts to the second entity until the first data is viewed by the second entity or until the second data is added to the ERP system.

5. The method of claim 1, wherein the facilitating comprises:
providing a user interface to be displayed to the second entity on the end user system, wherein the user interface includes the first data thereby enabling the second entity to view the first data.

6. The method of claim 5, wherein the first entity is a business organization and the second entity is a customer of the business organization,
wherein the first data is an invoice/purchase order for the customer raised by the business organization.

7. The method of claim 1, wherein the facilitating comprises:
providing a user interface to be displayed to the second entity on the end user system;
receiving from the end user system, the second data specified by the second entity using the user interface; and
storing the second data in the ERP system thereby enabling the second entity to add the second data to the ERP system.

8. The method of claim 7, wherein the first entity is a business organization and the second entity is a customer of the business organization,
wherein the second data is a unique identification number of the customer required by the business organization.

9. A system for secure data exchange between entities, the system comprising:
an end-user system operable to be used by a second entity;
an ERP system operable to:
sending on behalf of a first entity, a link to the second entity, wherein the first entity is an authorized user of the ERP system and the second entity is an unauthorized user of the ERP system;
receiving an indication that the link has been selected by the second entity in the end user system;
verifying, in response to the indication, the second entity based on the link; and
facilitating the second entity to either view a first data stored in the ERP system or add a second data to the ERP system.

10. The system of claim 9, wherein the link is an Uniform Resource Locator (URL) containing a first part and a second part,
wherein the first part causes the indication to be sent to the ERP system when the link is selected by the second entity,
wherein the second part is used for verifying the second entity.

11. The system of claim 9, wherein the first entity is enabled to specify a maximum count of the times the second entity is allowed to select the link,
wherein the ERP system maintains a running count of the times when the indication is received,
wherein the verifying and the facilitating is performed only when the running count is less than or equal to the maximum count.

12. The system of claim 9, wherein the first entity is enabled to specify a periodic alert to be sent to the second entity,
wherein the ERP system sends the periodic alerts to the second entity until the first data is viewed by the second entity or until the second data is added to the ERP system.

13. A non-transitory machine-readable medium storing one or more sequences of instructions for secure data exchange between entities, wherein execution of said one or more instructions by one or more processors contained in a digital processing system causes said digital processing system to perform the actions of:
sending on behalf of a first entity, a link to the second entity, wherein the first entity is an authorized user of the ERP system and the second entity is an unauthorized user of the ERP system;
receiving an indication that the link has been selected by the second entity in the end user system;
verifying, in response to the indication, the second entity based on the link; and
facilitating the second entity to either view a first data stored in the ERP system or add a second data to the ERP system.

14. The non-transitory machine-readable medium of claim 13, wherein the link is an Uniform Resource Locator (URL) containing a first part and a second part,
wherein the first part causes the indication to be sent to the ERP system when the link is selected by the second entity,
wherein the second part is used for verifying the second entity.

15. The non-transitory machine-readable medium of claim 13, wherein the first entity is enabled to specify a maximum count of the times the second entity is allowed to select the link,
wherein the ERP system maintains a running count of the times when the indication is received,
wherein the verifying and the facilitating is performed only when the running count is less than or equal to the maximum count.

16. The non-transitory machine-readable medium of claim 13, wherein the first entity is enabled to specify a periodic alert to be sent to the second entity,
wherein the ERP system sends the periodic alerts to the second entity until the first data is viewed by the second entity or until the second data is added to the ERP system.
